(19) United States
(12) Patent Application Publication
(10) Pub. No.: US 2017/0195537 A1
(43) Pub. Date: Jul. 6, 2017

(54) COMMUNICATION DEVICE ANTENNA ASSEMBLY AND COMMUNICATION DEVICE HAVING THE SAME

(71) Applicant: HON HAI PRECISION INDUSTRY CO., LTD., New Taipei (TW)

(72) Inventors: HAO-YING CHANG, New Taipei (TW); PAI-CHENG HUANG, New Taipei (TW); CHING-SUNG WANG, New Taipei (TW)

(21) Appl. No.: 15/361,289

(22) Filed: Nov. 25, 2016

(30) Foreign Application Priority Data
Dec. 31, 2015 (TW) 104144802

(51) Int. Cl. H04N 5/225; H04N 5/232; H04M 1/02; H04N 13/02

(52) U.S. Cl. CPC H04N 5/2257; H04N 5/2252; H04N 13/0296; H04N 5/23245; H04N 13/0239; H04M 1/0264; H04M 1/0277; H04N 2213/001

(57) ABSTRACT

A densely-packaged communication device with reduced mutual interference between camera and antenna includes a housing, a package case, a camera control device, an integrated circuit device, a circuit board, and an antenna. The package case is permanently grounded and is received in the housing. The camera control device is configured to control and drive the camera structure. The camera structure, the camera control device, the integrated circuit device, and the circuit board are housed in the package case to form a packaged structure, the antenna structure surrounds an outer side wall of the package case.

### FIELD

The subject matter herein generally relates to a communication device.

### BACKGROUND

Communication devices, such as mobile phones or tablet computers, usually have wireless communication functions. The communication device may also comprise a camera. However, when the device's communication antenna is arranged adjacent to the camera, the metallic bracket housing the camera may seriously degrade the radiation efficiency of the antenna. When the antenna is positioned away from the camera to improve radiation efficiency, quality of communication increases. Therefore, it would be better to avoid compromising the portability of the communication device to improve radiation efficiency.

### BRIEF DESCRIPTION OF THE DRAWINGS

Implementations of the present technology will now be described, by way of example only, with reference to the attached figures, wherein:

FIG. 1 is an isometric view of a first exemplary embodiment of a communication device.

FIG. 2 is an exploded view of the communication device of FIG. 1.

FIG. 3 is an enlarged schematic view, from another angle, of a package structure of the communication device of FIG. 2.

FIG. 4 is a second exemplary embodiment of a communication device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

One definition that applies throughout this disclosure will now be presented.

The term “comprising,” when utilized, means “including, but not necessarily limited to”; it specifically indicates open-ended inclusion or membership in the so-described combination, assembly, series, and the like.

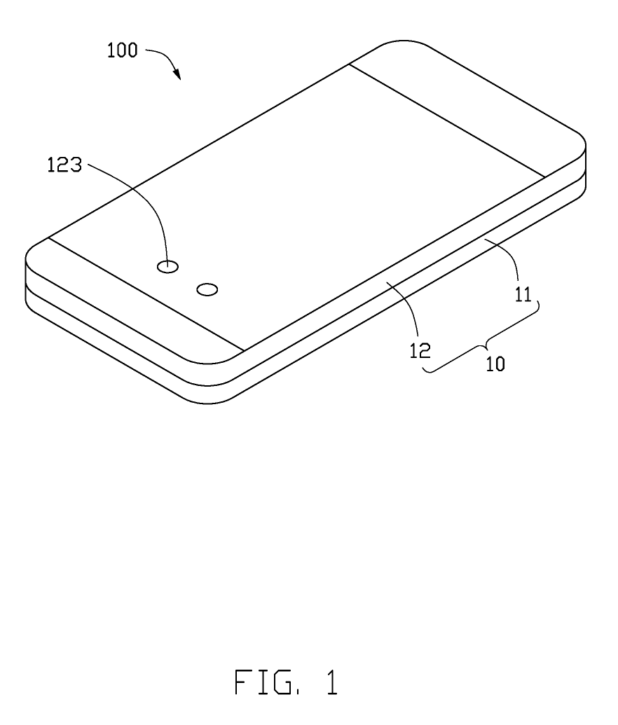

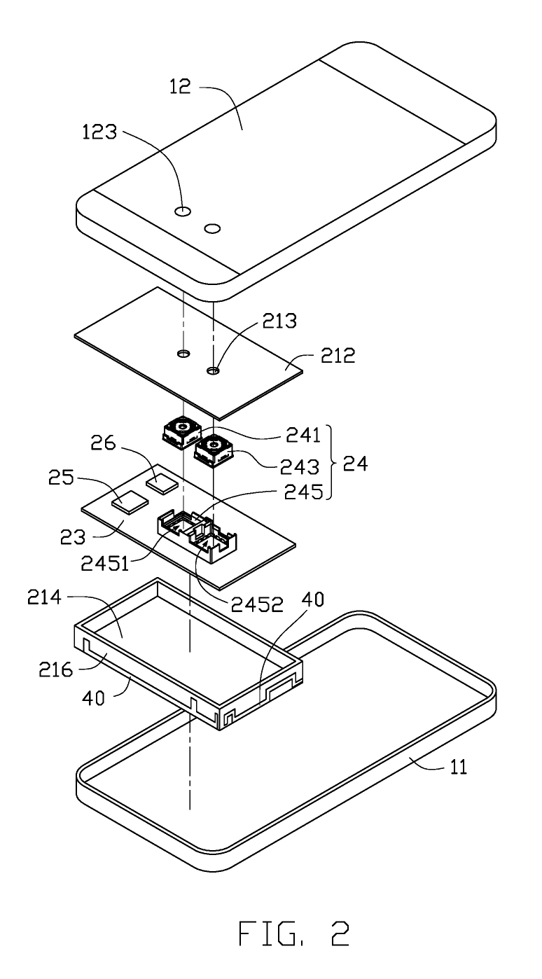

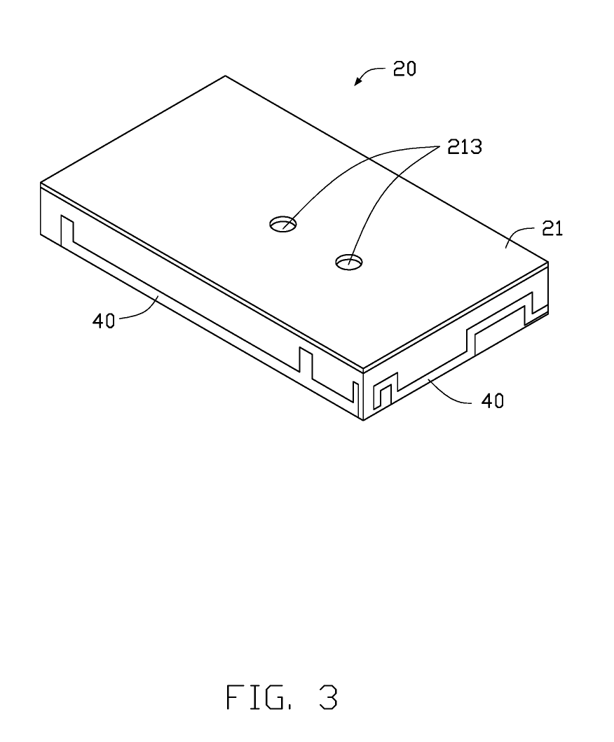

FIGS. 1 to 3 illustrate a first exemplary embodiment of a communication device 100. The communication device 100 comprises a housing 10, a package structure 20 received in the housing 10, and an antenna structure 40. In the exemplary embodiment, the communication device 100 is a mobile phone. In other exemplary embodiments, the communication device 100 may be another portable electronic device having a communication function, such as a tablet computer.

The housing 10 is substantially rectangular, and comprises an upper portion 11 and a lower portion 12. The upper portion 11 and the lower portion 12 attach together to define an enclosed space. At least one first opening 123 is defined in the lower portion 12. In the exemplary embodiment, the upper portion 11 is a front cover which defines a transparent window for receiving a display screen (not shown). The lower portion 12 is a back plate. The upper portion 11 and the lower portion 12 may be secured to each other by screws.

The package structure 20 comprises a package case 21, a circuit board 23, a camera structure 24, a camera control device 25, and an integrated circuit device 26. The camera structure 24 may be partially exposed through the housing 10. The camera structure 24, the camera control device 25, and the integrated circuit device 26 are positioned on the circuit board 23. The circuit board 23 is received in the enclosed space.

The package case 21 comprises a cover 212, a substrate 214, and four sidewalls 216. At least one second opening 213 is defined in the cover 212. In the exemplary embodiment, the cover 212 and the substrate 214 are substantially rectangular. In other exemplary embodiments, the cover 212 and the substrate 214 may be other polygonal shapes such as quadrilateral, pentagonal, and the like. The four sidewalls 216 are each positioned at a periphery of the substrate 214 and each extends perpendicularly from each edge of the substrate 214. In the exemplary embodiment, two first openings 123 are defined in the lower portion 12. Two second openings 213 are defined in the cover 212 and each aligns with each of the two first openings 123. In the exemplary embodiment, the package case 21 is made of an insulating material such as plastic. In the exemplary embodiment, the cover 212, the substrate 214, and the sidewalls 216 are secured together by a latching structure. In other exemplary embodiments, the cover 212, the substrate 214, and sidewalls 216 may be secured together by screws.

The circuit board 23 is positioned on the substrate 214. The circuit board 23 is substantially flat, and is used to supply voltage and control signals to the camera control device 25 and the integrated circuit device 26.

The camera structure 24 is electrically connected to the camera control device 25. The camera structure 24 comprises a first camera 241, a second camera 243, and a first frame 245. In other exemplary embodiments, the number of the cameras comprised in the camera structure 24 is not limited to two.

Both the first camera 241 and the second camera 243 have substantially the same orientation. The first camera 241 is exposed through one second opening 213 and one first opening 123. The second camera 243 is exposed through the other second opening 213 and the other first opening 123. Both the first camera 241 and the second camera 243 can capture pictures or videos. When in the picture capturing state, the first camera 241 and the second camera 243 are configured to capture pictures. When in the video capturing state, the first camera 241 and second camera 243 are configured to capture videos. In the exemplary embodiment, the first camera 241 and second camera 243 can work together to capture three-dimensional pictures. The first camera 241 and second camera 243 may also be in different states, so that the camera structure 30 can obtain still images and videos simultaneously, for example, the first camera 241 may be in the video capturing state and the second camera 243 may be in the picture capturing state, or the first camera 241 may be in the picture capturing state and the second camera 243 may be in the video capturing state. In the exemplary embodiment, the first camera 241 and the second camera 243 may have different focal length adjustment ranges. In other exemplary embodiments, the first camera 241 and the second camera 243 may have the same focal length adjustment range. In other exemplary embodiments, at least one of the first camera 241 and the second camera 243 can be rotated relative to the circuit board 23, to adjust an angle with respect to the circuit board 23.

The first frame 245 is electrically connected to a grounded area of the circuit board 23. The first frame 245 can form a discharge path by the circuit board 23 to reduce generation of static electricity. The first frame 245 defines a first chamber 2451 and a second chamber 2452. The first chamber 2451 is configured to receive the first camera 241. The second chamber 2452 is configured to receive the second camera 243. In the exemplary embodiment, the first frame 245 is made of metal. Inner surfaces of the first frame 245 define one or more projections (not shown) to engage with the first camera 241 or the second camera 243. In other exemplary embodiments, the inner surfaces of the first frame 245 are stepped surfaces to support the first lens 241 or the second lens 243.

The camera control device 25 is electrically connected to the circuit board 23. The camera control device 25 controls the first camera 241 and the second camera 243 simultaneously. In the exemplary embodiment, the camera control device 25 may control the first camera 241 or the second camera 243 to switch from a picture capturing state to a video capturing state, and may control the first camera 241 or the second camera 243 to rotate relative to the circuit board 23.

The integrated circuit device 26 is electrically connected to the circuit board 23. The communication device 100 has a wireless communication function and position locating function through the integrated circuit device 26. In the exemplary embodiment, the integrated circuit device 26 may comprise a long term evolution (LTE) device, a global positioning system (GPS), a WIFI communication device, and a BLUETOOTH device. The integrated circuit device 26 may work at a frequency band of 2.4 GHz, 5 GHz, or 60 GHz.

In the exemplary embodiment, both the first camera 241 and the second camera 243 are controlled by the camera control device 25 and the integrated circuit device 26. Thus, the first camera 241 and the second camera 243 are positioned on the same circuit board 23. The first camera 241 and the second camera 243 are mounted and packaged by the same package case 21 to improve integration of the communication device 100.

The antenna structure 40 is a planar antenna, and surrounds the sidewalls 216 of the package case 21. The antenna structure 40 may comprise a plurality of antennas made of metal. In the exemplary embodiment, the antenna structure 40 surrounds two adjacent sidewalls 216 of the package case 21.

Electromagnetic interference generated within the camera structure 24, the camera control device 25, and the integrated circuit device 26 can be avoided by positioning the antenna structure 40 at the sidewalls 216 of the package case 21. Furthermore, the camera structure 24, the camera control device 25, and the integrated circuit device 26 are all located within the package structure 20 to improve integration of the communication device 100 and maintain a portable communication device. Moreover, the first frame 245 can form a discharge path for the circuit board 23 to reduce generation of static electricity.

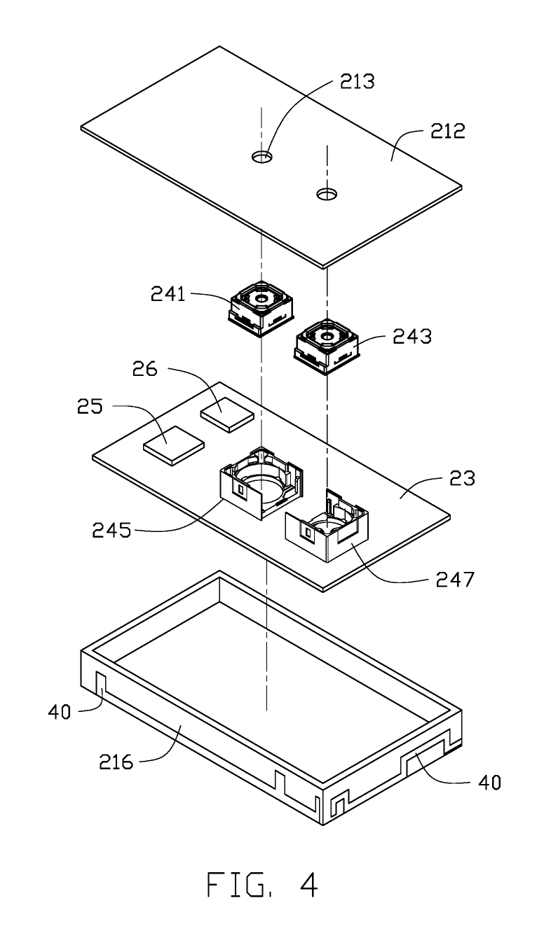

FIG. 4 illustrates a second exemplary embodiment of communication device 100.

The difference between the second exemplary embodiment and the first exemplary embodiment is that the camera structure 24 comprises a first frame 245 and a second frame 247.

The first frame 245 and the second frame 247 are electrically connected to the ground region of the circuit board 23. The first frame 245 and the second frame 247 can form a discharge path for the circuit board 23 to reduce generation of static electricity. The first frame 245 is configured to receive the first camera 241. The second frame 247 is configured to receive the second lens 243. The first frame 245 and the second frame 247 are integrally formed, and the first frame 245 and the second frame 247 are both made of metal. In the exemplary embodiment, one or more projections are positioned on inner surfaces of the first frame 245 and the second camera 247 to engage with the first camera 241 and the second camera 243. In other exemplary embodiments, the inner surfaces of the first frame 245 and the second frame 247 are stepped surfaces to support the first camera 241 and the second camera 243.

Both the first frame 245 and the second frame 247 can form a discharge path for the circuit board 23 to reduce generation of static electricity.

The exemplary embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including, the full extent established by the broad general meaning of the terms used in the claims.

What is claimed is:

1. A communication device comprising:
a housing; and
a package structure received in the housing, the package structure comprising:
a package case comprising a plurality of sidewalls;
a camera structure;
a camera control device configured to control the camera structure;
an integrated circuit device;
a circuit board; and
an antenna structure;
wherein the camera structure, the camera control device, the integrated circuit device, and the circuit board are received in the package case, the antenna structure surrounds at least one of the plurality of sidewalls of the package case.

2. The communication device of claim 1, wherein at least one first opening is defined in the housing, at least one second opening is defined in the package case, each of the at least one second opening aligned with the one first opening, and the camera is partially exposed through the at least one second opening and the at least one first opening.

3. The communication device of claim 1, wherein the camera structure, the camera control device, and the integrated circuit device are positioned on the circuit board.

4. The communication device of claim 1, wherein the camera structure comprises a first camera, a second camera, and a first frame, the first frame defines a first chamber and a second chamber, the first chamber is configured to receive the first camera, the second chamber is configured to receive the second camera, the first camera and the second camera have substantially a same orientation.

5. The communication device of claim 4, wherein when the first camera is in the video capturing state and the second camera in the picture capturing state, or when the first camera is in the picture capturing state and the second camera is in the video capturing state, the camera structure obtains still images and videos simultaneously.

6. The communication device of claim 4, wherein the first camera and the second camera have different focal length adjustment ranges.

7. The communication device of claim 4, wherein at least one of the first camera and the second camera is rotated relative to the circuit board to adjust an angle between the camera and the circuit board.

8. The communication device of claim 1, wherein the camera structure comprises a first camera, a second camera, a first frame, and a second frame, the first frame is configured to receive the first camera, the second frame is configured to receive the second camera, the first camera and the second camera have substantially a same orientation.

9. The communication device of claim 8, wherein the first frame and the second frame are integrally formed.

10. The communication device of claim 8, wherein both the first camera and the second camera are switchable between a picture capturing state and a video capturing state; the first camera and second camera work together in capturing pictures to obtain a three-dimensional picture.

11. The communication device of claim 1, wherein the package casing is made of an insulating material.

12. The communication device of claim 1, wherein the integrated circuit device comprises an LTE device, a global positioning system, a WIFI communication device and a Bluetooth device.
